(19) United States
(12) Patent Application Publication
(10) Pub. No.: US 2013/0020769 A1
(43) Pub. Date: Jan. 24, 2013

(54) Sealing Member and Its Manufacture

(71) Applicants: Hiroyuki Ueki, Ueda-shi (JP); Toru Noguchi, Nagano-shi (JP); Masaei Ito, Sagamihara-Shi (JP)

(72) Inventors: Hiroyuki Ueki, Ueda-shi (JP); Toru Noguchi, Nagano-shi (JP); Masaei Ito, Sagamihara-Shi (JP)

(73) Assignees: SCHLUMBERGER TECHNOLOGY CORPORATION, Sugar Land, TX (US); SHINSHU UNIVERSITY, Nagano-shi (JP); NISSHIN KOGYO CO., LTD., Ueda-Shi (JP)

(21) Appl. No.: 13/541,769

(22) Filed: Jul. 5, 2012

Related U.S. Application Data
(60) Provisional application No. 61/510,074, filed on Jul. 21, 2011.

(51) Int. Cl. C08K 3/04; C08L 27/12; F16J 15/16; B82Y 99/00

(52) U.S. Cl. 277/345; 524/495; 977/902

(57) ABSTRACT

A sealing member is obtained by molding a carbon fiber composite material (50) including a perfluoroelastomer (FFKM), and carbon nanofibers dispersed in the perfluoroelastomer, the carbon nanofibers having an average diameter of 0.4 to 230 nm. The perfluoroelastomer (FFKM) has a TR-10 value of −10° C. or less as measured by a temperature-retraction test (TR test) in accordance with JIS K 6261. The carbon fiber composite material (50) in a crosslinked form has a peak temperature of a loss tangent (tandelta) of −15° C. or less as measured by a dynamic viscoelasticity test.

### BACKGROUND OF THE INVENTION

The present invention relates to a sealing member using carbon nanofibers, and a method of producing the same.

The inventors of the invention proposed a method of producing a carbon fiber composite material that improves the dispersibility of carbon nanofibers using an elastomer so that the carbon nanofibers can be uniformly dispersed in the elastomer (see JP-A-2005-97525, for example). According to this method, the elastomer and the carbon nanofibers are mixed, so that the dispersibility of the carbon nanofibers with strong aggregating properties is improved due to a shear force. Specifically, when mixing the elastomer and the carbon nanofibers, the viscous elastomer enters the space between the carbon nanofibers while specific portions of the elastomer are bonded to highly active sites of the carbon nanofibers through chemical interaction. When a high shear force is applied to the mixture of the carbon nanofibers and the elastomer having an appropriately long molecular length and a high molecular mobility (exhibiting elasticity), the carbon nanofibers move along with the deformation of the elastomer. The aggregated carbon nanofibers are separated by the restoring force of the elastomer due to its elasticity after shearing, and become dispersed in the elastomer. Expensive carbon nanofibers can be efficiently utilized as a filler for a composite material by thus improving the dispersibility of the carbon nanofibers in the matrix.

The inventors also proposed a sealing material that exhibits excellent heat resistance, and includes a ternary fluoroelastomer, vapor-grown carbon fibers having an average diameter of more than 30 nm and 200 nm or less, and carbon black having an average particle size of 25 to 500 nm (see W02009/125503A1, for example).

However, further improvement has been required in the chemical resistance of a sealing member that is used in applications in which the sealing member is subjected to high temperature.

### SUMMARY

An object of the invention is to provide a sealing member that exhibits excellent heat resistance, excellent chemical resistance, and good low-temperature properties, and a method of producing the same.

According to a first aspect of the invention, there is provided a sealing member obtained by molding a carbon fiber composite material comprising a perfluoroelastomer (FFKM), and carbon nanofibers dispersed in the perfluoroelastomer, the carbon nanofibers having an average diameter of 0.4 to 230 nm,

the perfluoroelastomer (FFKM) having a TR-10 value of −10° C. or less as measured by a temperature-retraction test (TR test) in accordance with JIS K 6261, and

the carbon fiber composite material in a crosslinked form having a peak temperature of a loss tangent (tandelta) of −15° C. or less as measured by a dynamic viscoelasticity test.

According to a second aspect of the invention, there is provided a method of producing a sealing member comprising:

mixing a perfluoroelastomer (FFKM) and carbon nanofibers having an average diameter of 0.4 to 230 nm, and tight-milling the mixture at 0 to 50° C. using open rolls at a roll distance of 0.5 mm or less to obtain a carbon fiber composite material; and

molding the carbon fiber composite material to obtain a sealing member,

the perfluoroelastomer (FFKM) having a TR-10 value of −10° C. or less as measured by a temperature-retraction test (TR test) in accordance with JIS K 6261, and

the carbon fiber composite material in a crosslinked form having a peak temperature of a loss tangent (tandelta) of −15° C. or less as measured by a dynamic viscoelasticity test.

### BRIEF DESCRIPTION OF THE SEVERAL VIEWS OF THE DRAWING

FIG. 1 is a view schematically illustrating a method of producing a carbon fiber composite material.

FIG. 2 is a view schematically illustrating a method of producing a carbon fiber composite material.

FIG. 3 is a view schematically illustrating a method of producing a carbon fiber composite material.

FIG. 4 is a view schematically illustrating a tension fatigue test performed on a sealing member.

FIG. 5 is a schematic view illustrating a downhole apparatus in use.

FIG. 6 is a schematic view illustrating a part of a downhole apparatus.

FIG. 7 is a vertical cross-sectional view illustrating a pressure vessel connection portion of a downhole apparatus.

FIG. 8 is a vertical cross-sectional view illustrating another method of using an O-ring for a downhole apparatus.

FIG. 9 is a vertical cross-sectional view illustrating another method of using an O-ring for a downhole apparatus.

FIG. 10 is a cross-sectional view schematically illustrating a logging tool that is used for underground applications.

FIG. 11 is a partial cross-sectional view schematically illustrating the logging tool illustrated in FIG. 10.

FIG. 12 is an X-X′ cross-sectional view schematically illustrating a mud motor of the logging tool illustrated in FIG. 11.

### DETAILED DESCRIPTION OF THE EMBODIMENT

According to the invention, there is provided a sealing member obtained by molding a carbon fiber composite material including a perfluoroelastomer (FFKM), and carbon nanofibers dispersed in the perfluoroelastomer, the carbon nanofibers having an average diameter of 0.4 to 230 nm, the perfluoroelastomer having a TR-10 value of −10° C. or less as measured by a temperature-retraction test (TR test) in accordance with JIS K 6261, and the carbon fiber composite material in a crosslinked form having a peak temperature of a loss tangent (tandelta) of −15° C. or less as measured by a dynamic viscoelasticity test.

The sealing member according to the invention exhibits excellent heat resistance and chemical resistance due to the carbon fiber composite material in which the carbon fibers are dispersed in the perfluoroelastomer. The sealing member according to the invention also exhibits good low-temperature properties due to the perfluoroelastomer having a TR-10 value of 10° C. or less.

In the sealing member according to the invention, the carbon fiber composite material may include 7 to 35 parts by mass of the carbon nanofibers and 0 to 50 parts by mass of carbon black having an average particle size of 10 to 500 nm based on 100 parts by mass of the perfluoroelastomer (FFKM), and the carbon fiber composite material in a crosslinked form may have a number of cycles to fracture of 10,000 or more when subjected to a tension fatigue test at a temperature of 200° C., a maximum tensile stress of 2 N/mm, and a frequency of 1 Hz.

The sealing member according to the invention may be used for an oilfield apparatus.

In the sealing member according to the invention, the oilfield apparatus may be a logging tool that performs a logging operation in a borehole.

The sealing member according to the invention may be an endless sealing member that is disposed in the oilfield apparatus.

The sealing member according to the invention may be a stator of a fluid-driven motor that is disposed in the oilfield apparatus.

In the sealing member according to the invention, the fluid-driven motor may be a mud motor.

The sealing member according to the invention may be a rotor of a fluid-driven motor that is disposed in the oilfield apparatus.

In the sealing member according to the invention, the fluid-driven motor may be a mud motor.

According to the invention, there is provided a method of producing a sealing member comprising: mixing a perfluoroelastomer (FFKM) and carbon nanofibers having an average diameter of 0.4 to 230 nm, and tight-milling the mixture at 0 to 50° C. using open rolls at a roll distance of 0.5 mm or less to obtain a carbon fiber composite material; and molding the carbon fiber composite material to obtain a sealing member, the perfluoroelastomer (FFKM) having a TR-10 value of −10° C. or less as measured by a temperature-retraction test (TR test) in accordance with JIS K 6261, and the carbon fiber composite material in a crosslinked form having a peak temperature of a loss tangent (tandelta) of −15° C. or less as measured by a dynamic viscoelasticity test.

The method of producing a sealing member according to the invention can form a sealing member that exhibits excellent heat resistance and chemical resistance by utilizing the carbon fiber composite material in which the carbon nanofibers are dispersed in the perfluoroelastomer. The sealing member also exhibits good low-temperature properties due to the perfluoroelastomer having a TR-10 value of 10° C. or less.

These embodiments of the invention are described below in detail with reference to the drawings.

A sealing member according to one embodiment of the invention is obtained by molding a carbon fiber composite material including a perfluoroelastomer (FFKM), and carbon nanofibers dispersed in the perfluoroelastomer, the carbon nanofibers having an average diameter of 0.4 to 230 nm, the perfluoroelastomer (FFKM) having a TR-10 value of −10° C. or less as measured by a temperature-retraction test (TR test) in accordance with JIS K 6261, and the carbon fiber composite material in a crosslinked form having a peak temperature of a loss tangent (tandelta) of −15° C. or less as measured by a dynamic viscoelasticity test.

The perfluoroelastomer (FFKM) used to produce the sealing member is a fluororubber in which hydrogen atoms (H) bonded to carbon atoms in the main chain carbon-carbon (C—C) bond are fully fluorinated. A perfluoroelastomer normally exhibits excellent heat resistance and chemical resistance, but exhibits poor low-temperature properties. For example, the TR-10 value of a perfluoroelastomer is normally around 0° C. as measured by the temperature-retraction test (TR test) in accordance with JIS K 6261. On the other hand, the perfluoroelastomer used in one embodiment of the invention exhibits good low-temperature properties, and has a TR-10 value of −10° C. or less, preferably −15° C. or less, and particularly preferably −20° C. or less, as measured by the temperature-retraction test (TR test) in accordance with JIS K 6261. A sealing member that exhibits excellent chemical resistance and may be used in a wide temperature range from a low temperature to a high temperature is obtained using the perfluoroelastomer that exhibits good low-temperature properties. Examples of the perfluoroelastomer that exhibits good low-temperature properties include a tetrafluoroethylene (TFE)/perfluoroalkyl vinyl ether (PAVE) copolymer and the like. Examples of the perfluoroalkyl vinyl ether (PAVE) include perfluoromethoxy vinyl ether (PMOVE), perfluoromethyl vinyl ether (PMVE), perfluoroethyl vinyl ether (PEVE), perfluoropropyl vinyl ether (PPVE), and other similar compounds.

The average diameter (fiber diameter) of the carbon nanofibers used to produce the sealing member is 0.4 to 230 nm. The average diameter (fiber diameter) of the carbon nanofibers used to produce the sealing member may preferably be 9 to 110 nm, and may particularly preferably be 9 to 20 nm or 60 to 110 nm. Since the carbon nanofibers have a relatively small average diameter, the carbon nanofibers have a large specific surface area. Therefore, the surface reactivity of the carbon nanofibers with the perfluoroelastomer (matrix) is improved so that the dispersibility of the carbon nanofibers in the perfluoroelastomer can be improved. The perfluoroelastomer can be reinforced using the carbon nanofibers having an average diameter (fiber diameter) of 0.4 to 230 nm. A minute cell structure may be formed by the carbon nanofibers so that a three-dimensional network structure of the carbon nanofibers encloses the matrix material. It has been revealed in past studies that the maximum diameter of each cell is about twice to ten times the average diameter of the carbon nanofibers. The average diameter of the carbon nanofibers may be measured using an electron microscope. The carbon nanofibers may be subjected to an oxidation treatment in order to improve the surface reactivity of the carbon nanofibers with the perfluoroelastomer. The average diameter and the average length of the carbon nanofibers may be determined by measuring the diameter and the length of the carbon nanofibers in 200 areas or more from an image photographed using an electron microscope at a magnification of 5000 (the magnification may be appropriately changed depending on the size of the carbon nanofibers), and calculating the arithmetic mean values of the diameter and the length of the carbon nanofibers.

The amount of the carbon nanofibers that are included in the carbon fiber composite material may be appropriately determined depending on desired properties. The carbon fiber composite material may include 7 to 35 parts by mass of the carbon nanofibers and 0 to 50 parts by mass of carbon black having an average particle size of 10 to 500 nm based on 100 parts by mass of the perfluoroelastomer so that the carbon fiber composite material in a crosslinked form exhibits excellent abrasion resistance (e.g., has a number of cycles to fracture of 10,000 or more when subjected to a tension fatigue test at a temperature of 200° C., a maximum tensile stress of 2 N/mm, and a frequency of 1 Hz). The tension fatigue test can be used for evaluating the abrasion resistance of the carbon fiber composite material as described below. The amount of the carbon black may be adjusted depending on the average diameter or the amount of the carbon nanofibers. The carbon fiber composite material may include 10 to 25 parts by mass of the carbon nanofibers having an average diameter of 9 to 20 nm and 0 to 50 parts by mass of carbon black having an average particle size of 10 to 500 nm based on 100 parts by mass of the perfluoroelastomer so that the carbon fiber composite material in a crosslinked form exhibits excellent abrasion resistance as described above. When using the carbon nanofibers having an average diameter of 9 to 20 nm in an amount of 7 parts by mass or more and less than 10 parts by mass, the carbon fiber composite material may further include carbon black having an average particle size of 10 to 500 nm in an amount of 40 to 50 parts by mass. For example, the carbon fiber composite material may include 15 to 35 parts by mass of the carbon nanofibers having an average diameter of 60 to 110 nm and 15 to 50 parts by mass of carbon black having an average particle size of 10 to 500 nm based on 100 parts by mass of the perfluoroelastomer so that the carbon fiber composite material in a crosslinked form exhibits excellent abrasion resistance as described above. When using the carbon nanofibers having an average diameter of 9 to 20 nm, the abrasion resistance tends to be improved even if the amount of the carbon nanofibers is relatively small. When the amount of the carbon nanofibers is less than 10 parts by mass, the abrasion resistance can be improved by adding a relatively large amount of another reinforcing agent (e.g., carbon black having an average particle size of 10 to 500 nm). When using the carbon nanofibers having an average diameter of 60 to 110 nm, the abrasion resistance can be improved by adding another reinforcing agent (e.g., carbon black having an average particle size of 10 to 500 nm). The unit “parts by mass” indicates “phr” unless otherwise stated. “phr” is the abbreviation for “parts per hundred of resin or rubber”, and indicates the percentage of an additive or the like with respect to the rubber or the like.

The carbon nanofibers are multi-walled carbon nanotubes (MWCNT) having a shape obtained by rolling up a graphene sheet in the shape of a tube. Examples of carbon nanofibers having an average diameter of 9 to 20 nm include Baytubes C150P and Baytubes C70P (manufactured by Bayer MaterialScience), NC-7000 (manufactured by Nanocyl), and the like. Examples of carbon nanofibers having an average diameter of 60 to 110 nm include NT-7 (manufactured by Hodogaya Chemical Co., Ltd.) and the like. A carbon material having a partial carbon nanotube structure may also be used. The carbon nanotube may also be referred to as a graphite fibril nanotube or a vapor-grown carbon fiber.

The carbon nanofibers may be produced by a vapor growth method. The vapor growth method is also referred to as catalytic chemical vapor deposition (CCVD). The vapor growth method pyrolyzes a gas (e.g., hydrocarbon) in the presence of a metal catalyst to produce untreated first carbon nanofibers. As the vapor growth method, a floating reaction method that introduces an organic compound (e.g., benzene or toluene) (i.e., raw material) and an organotransition metal compound (e.g., ferrocene or nickelocene) (i.e., metal catalyst) into a reaction furnace set at a high temperature (e.g., 400 to 1000° C.) together with a carrier gas to produce first carbon nanofibers that are in a floating state or deposited on the wall of the reaction furnace, a substrate reaction method that causes metal-containing particles supported on a ceramic (e.g., alumina or magnesium oxide) to come in contact with a carbon-containing compound at a high temperature to produce carbon nanofibers on a substrate, or the like may be used. Carbon nanofibers having an average diameter of 9 to 20 nm may be produced by the substrate reaction method, and carbon nanofibers having an average diameter of 60 to 110 nm may be produced by the floating reaction method. The diameter of the carbon nanofibers may be adjusted by changing the size of the metal-containing particles, the reaction time, and the like. The carbon nanofibers having an average diameter of 9 to 20 nm may have a specific surface area by nitrogen adsorption of 10 to 500 m²/g, preferably 100 to 350 m²/g, and particularly preferably 150 to 300 m²/g.

When using carbon black in the carbon fiber composite material, carbon black of various grades produced using various raw materials may be used. The average particle size of the carbon black may be 10 to 500 nm, preferably 10 to 250 nm, and particularly preferably 40 to 230 nm. The average particle size of the carbon black refers to the arithmetic average particle size of the elementary particles. As the carbon black, reinforcement carbon black (e.g., SAF, ISAF, HAF, SRF, T, GPF, FT, MT) or the like may be used.

The sealing member is produced by molding and crosslinking the carbon fiber composite material. The carbon fiber composite material in a crosslinked form has a peak temperature of a loss tangent (tandelta) of −15° C. or less as measured by the dynamic viscoelasticity test. The peak temperature of the loss tangent (tandelta) of the carbon fiber composite material in a crosslinked form is in the region near the glass transition temperature (Tg) of the elastomer. The carbon fiber composite material loses its cushioning properties in the temperature region lower than the above peak temperature due to an increase in hardness. Therefore, the above peak temperature can be the critical use temperature (minimum use temperature) of the carbon fiber composite material. A perfluoroelastomer normally exhibits excellent chemical resistance and poor cold resistance as compared with a fluororubber (FKM). However, the perfluoroelastomer according to one embodiment of the invention has a TR-10 value of −10° C. or less. Thus, the carbon fiber composite material in a crosslinked form exhibits excellent cold resistance, heat resistance, and chemical resistance. The loss tangent (tandelta) may be obtained by determining the dynamic storage modulus (E″, dyn/cm²) and the dynamic loss modulus (E″, dyn/cm²) by carrying out a dynamic viscoelasticity test in accordance with JIS K 6394, and calculating the loss tangent (tandelta=E″/E′). The peak temperature of the loss tangent (tandelta) is a temperature at which a peak value is confirmed in the loss tangent (tandelta) curve.

### Method of Producing Sealing Member

A method of producing a sealing member according to one embodiment of the invention includes: mixing a perfluoroelastomer (FFKM) and carbon nanofibers having an average diameter of 0.4 to 230 nm, and tight-milling the mixture at 0 to 50° C. using open rolls at a roll distance of 0.5 mm or less to obtain a carbon fiber composite material; and molding the carbon fiber composite material to obtain a sealing member, the perfluoroelastomer having a TR-10 value of −10° C. or less as measured by a temperature-retraction test (TR test) in accordance with JIS K 6261, and the carbon fiber composite material in a crosslinked form having a peak temperature of a loss tangent (tandelta) of −15° C. or less as measured by a dynamic viscoelasticity test. The method of producing a sealing member is described in detail below with reference to FIGS. 1 to 3.

FIGS. 1 to 3 are views schematically illustrating the method of producing a sealing member according to one embodiment of the invention that utilizes an open-roll method.

As shown in FIGS. 1 to 3, a first roll 10 and a second roll 20 of open rolls 2 are disposed at a given distance d (e.g., 0.5 to 1.5 mm). The first roll 10 and the second roll 20 are respectively rotated at rotation speeds V1 and V2 in the directions indicated by arrows in FIGS. 1 to 3, or in the reverse directions. As shown in FIG. 1, a perfluoroelastomer 30 that is wound around the first roll 10 is masticated so that the molecular chains of the perfluoroelastomer are moderately cut to produce free radicals. The free radicals of the perfluoroelastomer produced by mastication are easily bonded to carbon nanofibers.

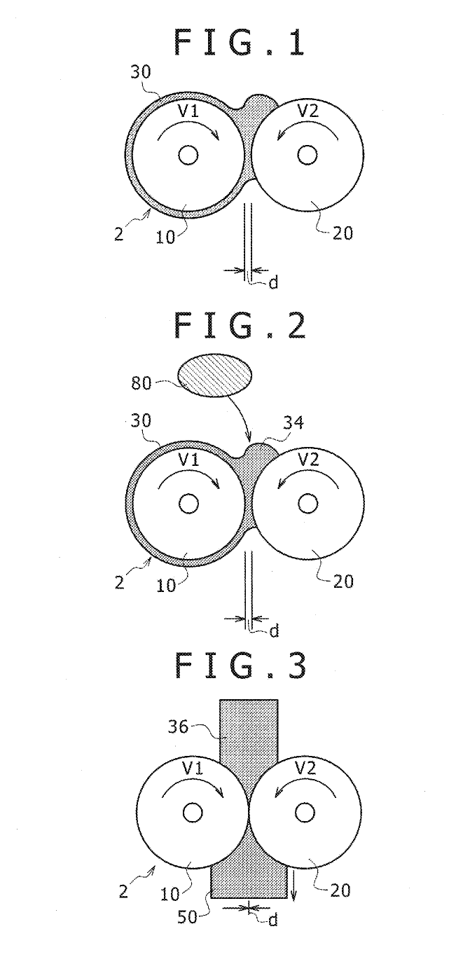

As shown in FIG. 2, carbon nanofibers 80 are supplied to a bank 34 of the perfluoroelastomer 30 wound around the first roll 10 optionally together with a filler (not shown), and the perfluoroelastomer 30 and the carbon nanofibers 80 are mixed. The temperature of the perfluoroelastomer 30 may be 0 to 50° C., and preferably 10 to 20° C., for example. The perfluoroelastomer 30 and the carbon nanofibers 80 may be mixed using an internal mixing method, a multi-screw extrusion kneading method, or the like instead of the open-roll method.

As shown in FIG. 3, the distance d between the first roll 10 and the second roll 20 is set to 0.5 mm or less, and preferably 0 to 0.5 mm, for example. A mixture 36 is then supplied to the open rolls 2, and tight-milled. The mixture 36 may be tight-milled about one to ten times, for example. When the surface velocity of the first roll 10 is referred to as V1, and the surface velocity of the second roll 20 is referred to as V2, the surface velocity ratio (V1/V2) of the first roll 10 to the second roll 20 during tight-milling may be 1.05 to 3.00, and is preferably 1.05 to 1.2. A desired shear force can be applied by utilizing such a surface velocity ratio. A carbon fiber composite material 50 that is extruded through the narrow space between the rolls is deformed to a large extent as a result of the restoring force of the perfluoroelastomer 30 due to elasticity (see FIG. 3), so that the carbon nanofibers 80 move to a large extent together with the perfluoroelastomer 30. The carbon fiber composite material 50 obtained by tight-milling is rolled (sheeted) by the rolls to a given thickness. The tight-milling step may be performed while setting the roll temperature at a relatively low temperature (e.g., 0 to 50° C., and preferably 5 to 30° C.) in order to obtain as high a shear force as possible. The measured temperature of the perfluoroelastomer 30 may be adjusted to 0 to 50° C. This causes a high shear force to be applied to the perfluoroelastomer 30 so that the aggregated carbon nanofibers 80 are removed by the molecules of the perfluoroelastomer one by one, and become dispersed in the perfluoroelastomer 30. Since the perfluoroelastomer 30 has elasticity, viscosity, and chemical interaction with the carbon nanofibers, the carbon nanofibers can be easily dispersed. As a result, the carbon fiber composite material 50 in which carbon nanofibers have excellent dispersibility and dispersion stability (i.e., carbon nanofibers rarely reaggregate) can be obtained.

Specifically, when mixing the perfluoroelastomer and the carbon nanofibers using the open rolls, the viscous perfluoroelastomer enters the space between the carbon nanofibers, and specific portions of the perfluoroelastomer are bonded to highly active sites of the carbon nanofibers through chemical interaction. When the carbon nanofibers have a moderately active surface, the carbon nanofibers are easily bonded to the molecules of the perfluoroelastomer. When a high shear force is then applied to the perfluoroelastomer, the carbon nanofibers move along with the movement of the perfluoroelastomer molecules so that the aggregated carbon nanofibers are separated by the restoring force of the perfluoroelastomer due to its elasticity after shearing, and become dispersed in the perfluoroelastomer. According to one embodiment of the invention, when the carbon fiber composite material is extruded through the narrow space between the rolls, the carbon fiber composite material is deformed to a thickness greater than the roll distance as a result of the restoring force of the perfluoroelastomer due to its elasticity. It is considered that the above deformation causes the carbon fiber composite material to which a high shear force is applied to flow in a more complicated manner to disperse the carbon nanofibers in the perfluoroelastomer. The dispersed carbon nanofibers are prevented from reaggregating due to chemical interaction with the perfluoroelastomer, and exhibit excellent dispersion stability.

In the step of dispersing the carbon nanofibers in the perfluoroelastomer by a shear force, an internal mixing method or a multi-screw extrusion kneading method may be used instead of the open-roll method. In other words, it suffices that a shear force sufficient to separate the aggregated carbon nanofibers be applied to the perfluoroelastomer. It is preferable to use the open-roll method because the actual temperature of the mixture can be measured and managed while managing the roll temperature. A crosslinking agent may be added before or when mixing the perfluoroelastomer and the carbon nanotubes, or mixed into the carbon fiber composite material that has been tight-milled and sheeted, and the carbon fiber composite material may thus be crosslinked to obtain a crosslinked carbon fiber composite material. For example, the perfluoroelastomer may be crosslinked by peroxide vulcanization that is not affected by heat.

A sealing member may be obtained by molding the carbon fiber composite material into a desired shape (e.g., endless shape) using a rubber molding method (e.g., injection molding, transfer molding, press molding, extrusion molding, or calendering). The sealing member may be formed of the carbon fiber composite material in a crosslinked form.

In the method of producing a carbon fiber composite material according to one embodiment of the invention, a compounding ingredient that is normally used when processing a perfluoroelastomer may be added. A known compounding ingredient may be used. Examples of the compounding ingredient include a crosslinking agent, a vulcanizing agent, a softener, a plasticizer, a reinforcing agent, a filler, a colorant, and the like. These compounding ingredients may be added to the perfluoroelastomer at an appropriate timing during the mixing process. A peroxide may be used as the crosslinking agent. The crosslinking agent may be added before mixing the carbon nanofibers into the perfluoroelastomer, or may be added together with the carbon nanofibers, or may be added after mixing the carbon nanofibers and the perfluoroelastomer, for example. The crosslinking agent may be added to the uncrosslinked carbon fiber composite material after tight-milling in order to prevent scorching, for example.

The sealing member exhibits excellent high-temperature properties and abrasion resistance as a result of reinforcing the perfluoroelastomer with the carbon nanofibers. Therefore, the sealing member may be used as a static sealing member and a dynamic sealing member. The sealing member may have a known shape (e.g., endless shape). For example, the sealing member may be an O-ring, an angular seal having a rectangular cross-sectional shape, a D-ring having a cross-sectional shape in the shape of the letter “D”, an X-ring having a cross-sectional shape in the shape of the letter “X”, an E-ring having a cross-sectional shape in the shape of the letter “E”, a V-ring having a cross-sectional shape in the shape of the letter “V”, a U-ring having a cross-sectional shape in the shape of the letter “U”, an L-ring having a cross-sectional shape in the shape of the letter “L”, or the like. The sealing member may be used as a stator or a rotor of a fluid-driven motor (e.g., mud motor).

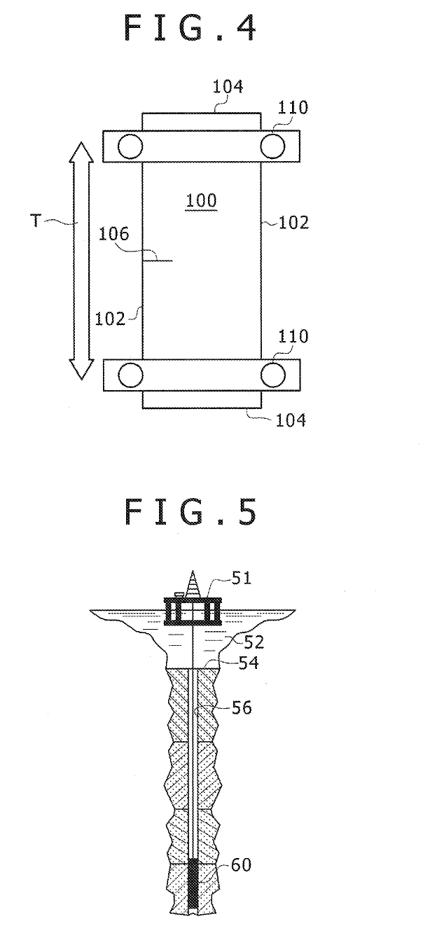

FIG. 4 is a view schematically illustrating a tension fatigue test performed on a sealing member according to one embodiment of the invention.

As shown in FIG. 4, a strip-shaped specimen 100 (length: 10 mm, width: 4 mm, thickness: 1 mm) is punched from the carbon fiber composite material in a crosslinked form. A cut 106 (depth: 1 mm) is formed in the widthwise direction from the center of a long side 102 of the specimen 100. Each end of the specimen 100 near a short side 104 is held using a chuck 110. The specimen 100 is subjected to a tension fatigue test by repeatedly applying a tensile load (0 to 2 N/mm) to the specimen 100 in the direction indicated by an arrow T (see FIG. 4) in air at a temperature of 200° C. and a frequency of 1 Hz to measure the number of tensile load application operations (i.e., tension fatigue life) performed until the specimen 100 breaks up to 200,000. The cut 106 may be formed in the specimen 100 by cutting the specimen 100 to a depth of 1 mm using a razor blade. It is considered that the abrasion resistance of a rubber composition can be evaluated by the above tension fatigue test instead of using a known rubber composition abrasion resistance test method. A phenomenon in which a rubber composition wears away due to friction is considered to occur when the rubber composition is torn off by the contact surface. Therefore, when the tension fatigue test is performed in a state in which the cut 106 is formed in the specimen, and the specimen does not break even if a large number of tensile load application operations have been performed, it is considered that the sealing member exhibits excellent abrasion resistance. The tension fatigue life measured by the above tension fatigue test is referred to as a first number of tensile load application operations. A tension fatigue test may be performed in the same manner as described above, except for changing the tensile load to 0 to 2.5 N/mm, to measure the tension fatigue life that is indicated by a second number of tensile load application operations. The tension fatigue life ratio of the second number of tensile load application operations to the first number of tensile load application operations may be used as an index of the abrasion resistance of the sealing member under high pressure. The closer the tension fatigue life ratio to 1, the more excellent the abrasion resistance of the sealing member under high pressure. The tension fatigue life ratio may be 0.5 to 1.0, and preferably 0.6 to 1.0, for example.

The molecular chains of part of the perfluoroelastomer are cut during mixing so that free radicals are produced around the carbon nanofibers. The free radicals attack and adhere to the surface of the carbon nanofibers so that an interfacial phase (aggregates of the molecules of the perfluoroelastomer) is formed. The interfacial phase is considered to be similar to a bound rubber that is formed around carbon black when mixing an elastomer and carbon black, for example. The interfacial phase covers and protects the carbon nanofibers. When adding the carbon nanofibers in an amount equal to or larger than a given value, nanometer-sized cells of the perfluoroelastomer that are enclosed by the linked interfacial phases are considered to be formed. These small cells are almost homogeneously formed over the entire carbon fiber composite material so that an effect that exceeds an effect achieved by merely combining two materials is expected to be achieved.

The sealing member according to one embodiment of the invention may be used for oilfield applications under severe conditions. This is because the sealing member exhibits excellent heat resistance, excellent chemical resistance, and good low-temperature properties as mentioned above. The oilfield applications are described in detail below.

### Oilfield Applications

The sealing member for oilfield applications may be used for an oilfield apparatus, for example. The sealing member may be used as a static sealing member or a dynamic sealing member of the oilfield apparatus. For example, when using the sealing member for a logging tool, a rotating machine (e.g., motor), a reciprocating machine (e.g., piston), or the like, the sealing member achieves excellent effects as a dynamic sealing member. Typical embodiments of the oilfield apparatus are described below.

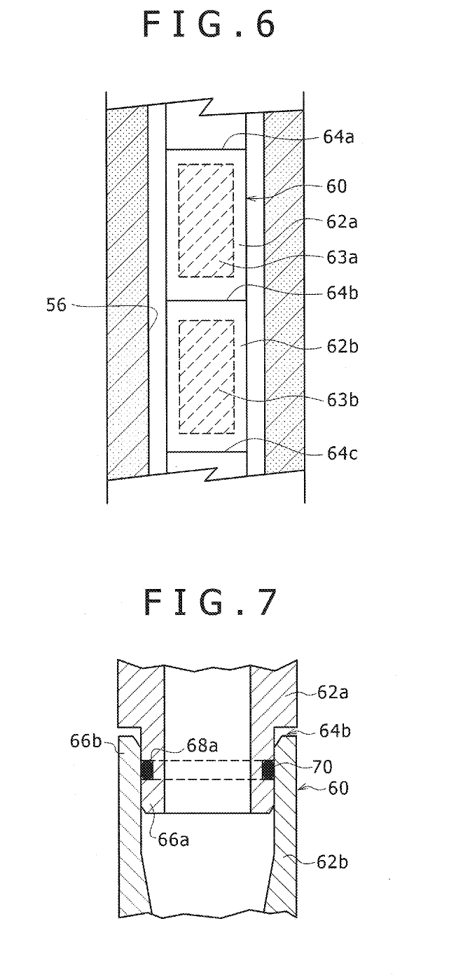

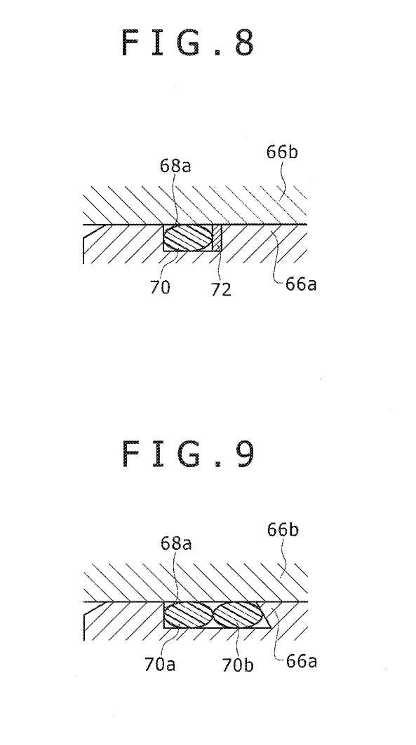

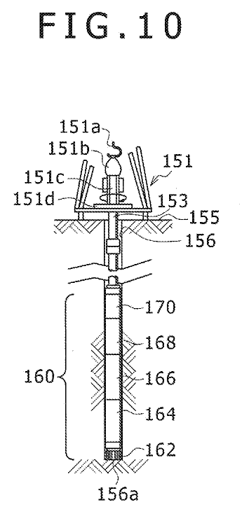

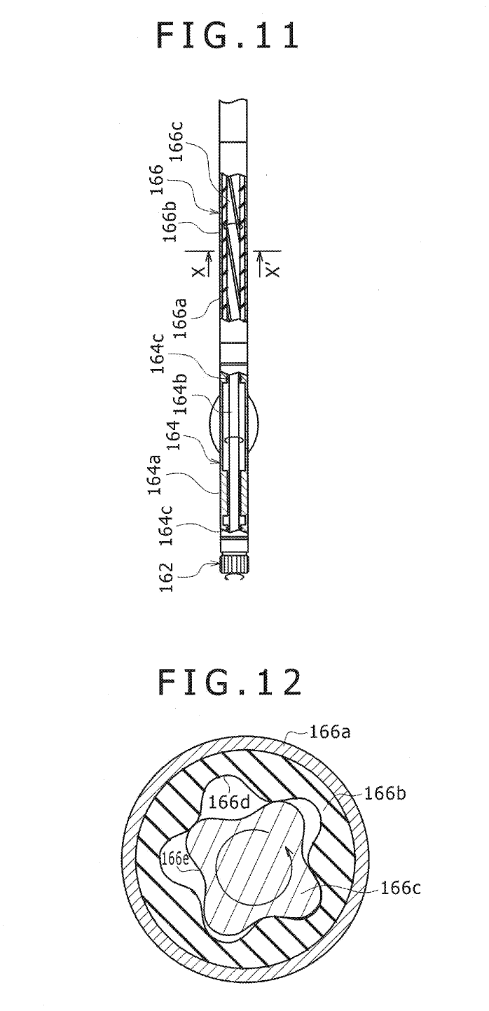

A sealing member according to one embodiment of the invention that is used for the logging tool is described below with reference to FIGS. 5 to 12. FIG. 5 is a schematic view illustrating a downhole apparatus in use. FIG. 6 is a schematic view illustrating part of a downhole apparatus. FIG. 7 is a vertical cross-sectional view illustrating a pressure vessel connection portion of a downhole apparatus. FIG. 8 is a vertical cross-sectional view illustrating another method of using an O-ring for a downhole apparatus. FIG. 9 is a vertical cross-sectional view illustrating another method of using an O-ring for a downhole apparatus. FIG. 10 is a cross-sectional view schematically illustrating a logging tool according to one embodiment of the invention that is used for underground applications. FIG. 11 is a partial cross-sectional view schematically illustrating the logging tool according to one embodiment of the invention illustrated in FIG. 10. FIG. 12 is an X-X′ cross-sectional view schematically illustrating a mud motor of the logging tool illustrated in FIG. 11.

The logging tool records physical properties of a formation, a reservoir, and the like inside and around a borehole, geometrical properties (e.g., pore size, orientation, and slope) of a borehole or a casing, the flow behavior of a reservoir, and the like at each depth. For example, the logging tool may be used in an oilfield. For example, the logging tool may be used for subsea applications illustrated in FIG. 5 or underground applications illustrated in FIG. 10. The logging tool is classified as a wireline log/logging tool, a mud logging tool, a logging-while-drilling (LWD) tool, a measurement-while-drilling (MWD) tool (i.e., a measuring instrument is provided in a drilling assembly), and the like. Since these logging tools are used at a deep underground position, the sealing member is subjected to a severe environment. It may be necessary for the sealing member to endure friction at a high temperature (particularly 175° C. or more) to maintain liquid-tightness. Therefore, the sealing member may be required to exhibit heat resistance higher than that required for an HNBR composite material.

As shown in FIG. 5, when searching for underground resources, a downhole apparatus 60 is caused to advance in a well 56 (vertical or horizontal passageway) formed in an ocean floor 54 from a platform 51 on the sea 52, and the underground structure and the like are probed to determine the presence or absence of the target substance (e.g., petroleum), for example. The downhole apparatus 60 is secured on the end of a long rod extending from the platform 51, for example. The downhole apparatus 60 includes a plurality of pressure vessels 62a and 62b illustrated in FIG. 6, and may also include a drill bit (not shown) at the end. The adjacent pressure vessels 62a and 62b are liquid-tightly connected through connection portions 64a, 64b, and 64c on either end. Electronic instruments 63a and 63b (e.g., sonic logging system) are respectively enclosed in the pressure vessels 62a and 62b so that the underground structure and the like can be probed.

As shown in FIG. 7, an end 66a of the pressure vessel 62a has a cylindrical shape having an outer diameter smaller to some extent than the inner diameter of an end 66b of the pressure vessel 62b. An endless sealing member (e.g., O-ring 70) is provided in a groove 68a formed in the outer circumferential surface of the end 66a. The O-ring 70 is a circular endless sealing member formed using the heat-resistant sealing material and having an external shape without ends. The O-ring 70 has a circular horizontal cross-sectional shape. The connection portion 64b between the pressure vessels 62a and 62b is liquid-tightly sealed by inserting the end 66a of the pressure vessel 62a into the end 66b of the pressure vessel 62b so that the O-ring 70 is flatly deformed. Since the downhole apparatus 60 is operated in the well 56 formed deep in the ground, it is necessary to liquid-tightly keep the pressure vessels 62a and 62b at a high temperature under high pressure. In the O-ring 70 for the downhole apparatus 60 according to one embodiment of the invention, the elastomer deteriorates to only a small extent at a high temperature. Moreover, the O-ring 70 can maintain excellent flexibility and strength at a high temperature.

As shown in FIG. 8, a resin back-up ring 72 may be provided in the groove 68a in addition to the O-ring 70, for example. As shown in FIG. 9, two O-rings 70a and 70b may be provided in the groove 68a to improve the seal performance, for example.

As shown in FIG. 10, when probing underground resources from ground 155 using a measuring instrument provided in a drilling assembly, a platform and a derrick assembly 151 that are disposed over a borehole 156, and a bottom hole assembly (BHA) 160 (i.e., logging tool) that is disposed in a borehole 156 (vertical or horizontal passageway) formed under the derrick assembly 151 are used, for example. The derrick assembly 151 includes a hook 151a, a rotary swivel 151b, a kelly 151c, and a rotary table 151d. The bottom hole assembly 160 is secured on the end of a long drill string 153 that extends from the derrick assembly 151, for example. Mud is supplied to the drill string 153 from a pump (not shown) through the rotary swivel 151b to drive a fluid-driven motor of the bottom hole assembly 160. The above embodiment has been described taking an example in which the bottom hole assembly 160 includes a drill bit 162, a rotary steerable system 164, a mud motor 166, a measurement-while-drilling module 168, and a logging-while-drilling module 170. Note that the elements may be appropriately selected and combined depending on the logging application.

The rotary steerable system 164 illustrated in FIG. 11 includes a deviation mechanism (not shown) that causes the drill bit 162 to deviate in a given direction in a state in which the drill bit 162 rotates to enable directional drilling. The sealing member according to one embodiment of the invention may be applied to the rotary steerable system 164. The rotary steerable system 164 requires a sealing member that exhibits high abrasion resistance at about 210° C. or less, or a sealing member that exhibits high chemical resistance against mud, for example. A related-art sealing member may not properly function due to wear and tear of the rubber. This problem may be serious in a severe chemical environment. The sealing member for a rotary steerable system disclosed in US-A-2006/0157283 is required to function at a high sliding speed (100 mm/sec or less). However, the above problems of the sealing member may be exacerbated by reduced properties of the elastomer at the usage temperature and the abrasive nature of the drilling fluid. On the other hand, when using the sealing member according to one embodiment of the invention as the sealing member of the rotary steerable system 164, the above problems can be solved by high abrasion resistance for sealing drilling mud that contains particles, better chemical resistance against exposure to a wide range of drilling fluids, and better mechanical properties at a high temperature that reduce tearing in addition to the above properties of the sealing member. The rotary steerable system 164 includes a cylindrical housing 164a that does not rotate, a transmission shaft 164b that is disposed through the housing 164a and transmits the rotational force of the mud motor 166 to the drill bit 162, and a sealing member 164c that rotatably supports the transmission shaft 164b inside the housing 164a. The sealing member 164c may be an endless O-ring that is fitted into a circular groove formed in the housing 164a, for example. The sealing member 164c seals the space between the housing 164a and the surface of the rotating transmission shaft 164b. When using the sealing member produced by the method of producing a sealing member as the sealing member 164c, the sealing member 164c can maintain the sealing function for a long time since the sealing member 164c exhibits excellent abrasion resistance in a severe underground environment at a high temperature (e.g., about 200° C. or less). For example, use of such a sealing member is disclosed in US-A-2006/0157283 and U.S. Pat. No. 7,188,685, the entire disclosure of which is incorporated by reference herein. Specifically, FIG. 5 of US-A-2006/0157283 discloses a sealing member 38 on a piston 36 that seals on a bore 30 in a bias unit of a rotary steerable assembly. U.S. Pat. No. 7,188,685 discloses a bias unit.

The mud motor 166 illustrated in FIG. 12 is also referred to as a downhole motor. The mud motor 166 is a fluid-driven motor that is driven by the flow of mud and rotates the drill bit 162. Examples of the mud motor 166 include a mud motor for deviated wellbore drilling applications. The sealing member according to one embodiment of the invention may be applied to the mud motor 166. The mud motor 166 requires a sealing member that exhibits high-temperature properties at about 150 to 200° C., a sealing member that can function under extreme abrasive conditions, or a sealing member that exhibits chemical resistance to handle a wide range of drilling muds, for example. A related-art sealing member for a mud motor may swell, and may show seal failures from cracking and removal of large pieces of the sealing member body (chunking), seal failures from abrasion at a high temperature, and local heating and increased degradation of the sealing member from the abrasive action of the sealing member, for example. On the other hand, when using the sealing member according to one embodiment of the invention as the sealing member of the mud motor 166, the above problems can be solved by better mechanical properties at a high temperature to reduce tearing and chunking, better chemical resistance against exposure to a wide range of drilling fluids, a reduction in local heat spots due to better thermal conductivity, and the like, in addition to the above properties of the sealing member. The mud motor 166 includes a cylindrical housing 166a, a tubular stator 166 that is secured on the inner circumferential surface of the housing 166a, and a rotor 166c that is rotatably disposed inside a stator 166d. For example, five spiral grooves extend in an inner circumferential surface 166d of the stator 166b from the rotary steerable system 164 to the measurement-while-drilling module 168. The sealing member according to one embodiment of the invention that is produced in the method of producing a sealing member may be used as the stator 166b. For example, an outer circumferential surface 166e of the rotor 166c formed of a metal has four threads that protrude spirally. The threads are disposed along the grooves formed in the inner circumferential surface 166d of the stator 166b. As shown in FIG. 12, the inner circumferential surface 166d of the stator 166b and the outer circumferential surface 166e of the rotor 166c partially come in contact with each other. A mud passage is formed inside an opening 166f between the inner circumferential surface 166d and the outer circumferential surface 166e. Mud that flows through the opening 166f comes in contact with the outer circumferential surface 166e of the rotor 166c so that the rotor 166c eccentrically rotates inside the stator 166b in the direction indicated by an arrow illustrated in FIGS. 11 and 12, for example. Since the inner circumferential surface 166d of the stator 166b comes in contact with the outer circumferential surface 166e of the rotor 166c and the rotor 166c eccentrically rotates due to mud, the inner circumferential surface 166d of the stator 166b functions in the same manner as a sealing member. Since the stator 166b exhibits excellent abrasion resistance in a severe underground environment, the rotor 166c of the mud motor 166 can be rotated for a long time. Although the mud motor 166 has been described above as an example of the fluid-driven motor, the sealing member may also be applied to another fluid-driven motor that has a similar structure and is driven using a fluid. The rotor may be formed of the sealing member that is produced by the method of producing a sealing member, and the stator may be formed of a metal, for example. For example, use of such a sealing member is disclosed in US-A-2006/0216178 and U.S. Pat. No. 6,604,922, the entire disclosure of which is incorporated by reference herein. Specifically, FIG. 3 of US-A-2006/0216178 discloses an elastomeric stator (lining) (i.e., sealing member) that provides a sealing function against a rotor to generate drilling torque on the rotor. Mud flows between the stator and the rotor. FIG. 4 of US-A-2006/0216178 discloses an elastomeric sleeve (i.e., sealing member) that is attached to a rotor that provides a sealing function against a stator. FIG. 5 of US-A-2006/0216178 discloses an elastomeric sleeve (i.e., sealing member) on a rotor that provides a sealing function against a stator. FIG. 4 of U.S. Pat. No. 6,604,922 discloses that a resilient layer in a liner attached to a stator provides a sealing function. The resilient layer functions as a sealing member. FIG. 13 of U.S. Pat. No. 6,604,922 discloses that a rotor lining formed by an elastomer layer provides a sealing function. The elastomer layer functions as a sealing member.

The measurement-while-drilling module 168 includes a measurement-while-drilling instrument (not shown) that is disposed inside a chamber 168a provided on a wall of a pipe (drill collar) that has a thick wall. The measurement-while-drilling instrument includes various sensors. For example, the measurement-while-drilling instrument measures bottom hole data (e.g., orientation, slope, bit direction, load, torque, temperature, and pressure), and transmits the measured data to the ground in real time.

The logging-while-drilling module 170 includes a logging-while-drilling instrument (not shown) that is disposed inside a chamber 170a provided on a wall of a pipe (drill collar) that has a thick wall. The logging-while-drilling instrument includes various sensors. For example, the logging-while-drilling instrument measures specific resistivity, porosity, acoustic wave velocity, gamma-rays, and the like to obtain physical logging data, and transmits the physical logging data to the ground in real time.

The sealing member according to one embodiment of the invention that is produced in the method of producing a sealing member may be used for the measurement-while-drilling module 168 and the logging-while-drilling module 170 inside the chambers 168a and 170a in order to protect the sensors from mud and the like.

The oilfield application is not limited to the logging tool. For example, the sealing member according to one embodiment of the invention may be used for a downhole tractor used for wireline log/logging. Examples of the downhole tractor include “MaxTRAC” or “TuffTRAC” (trademark; manufactured by Schlumberger Limited). The downhole tractor requires a reciprocating sealing member having high abrasion resistance for longer operational life and reliability at about 175° C. or less.

A related-art sealing member requires high polishing on the surface of a sealing piston provided in the downhole tractor. This leads to a high reject rate of the mirror-finished piston and cylinder surfaces during manufacturing. A related-art sealing member based on standard elastomers leads to wear, leakage, reduced tool life and failures. A sealing member may be subjected to a high sliding speed of up to 2000 ft/hour. A sealing member used for the downhole tractor must function with hydraulic oil on both sides, or oil on one side and mud or other well fluids, possibly with particulates, on the other. A tractor job requires a sliding sealing member to sufficiently function over a sliding length exceeding the tractoring distance. For example, a 10,000-ft tractoring job requires some of the sealing members to reliably function over a cumulative sliding distance of 20,000 ft or less. Moreover, a differential pressure of 200 psi or less is applied across the sealing member.

The above problems can be solved by utilizing the sealing member according to one embodiment of the invention for the downhole tractor due to the above properties of the sealing member. In particular, a relaxed finish on the sealing piston and cylindrical surfaces provides lower manufacturing costs. Moreover, superior abrasion resistance ensures longer life and a reliable seal function. In addition, lower friction allows longer seal life.

For example, use of such a sealing member is disclosed in U.S. Pat. No. 6,179,055, the entire disclosure of which is incorporated by reference herein. Specifically, FIGS. 7A and 8A of U.S. Pat. No. 6,179,055 disclose a sealing member on a piston. FIGS. 7B, 10B, and 12 of U.S. Pat. No. 6,179,055 also disclose a sealing member on a piston. FIGS. 15, 12, and 16B of U.S. Pat. No. 6,179,055 disclose a sealing member on a piston to seal against a tube and a housing. FIG. 16B of U.S. Pat. No. 6,179,055 discloses a sealing member on a rod.

The sealing member according to one embodiment of the invention may also be applied to a formation testing and reservoir fluid sampling tool, for example. Examples of the formation testing and reservoir fluid sampling tool include “Modular Formation Dynamics Tester (MDT)” (trademark; manufactured by Schlumberger Limited). The formation testing and reservoir fluid sampling tool requires a sealing member that exhibits high abrasion resistance in a pump-out module and other pistons. The formation testing and reservoir fluid sampling tool also requires a sealing member that exhibits high abrasion resistance and high-temperature properties (210° C. or less) for sealing against the wellbore.

A piston in a displacement unit of a pump-out module sees a large number cycles (reciprocating motion) to move, extract, or pump a reservoir fluid for sampling, tool actuation, and analysis. A piston seal using a related-art sealing member tends to wear, and fails after limited service life. This problem occurs to a large extent at a higher temperature. Moreover, particles in the fluid accelerate wear and damage of the sealing member.

The above problems can be solved by utilizing the sealing member according to one embodiment of the invention for the formation testing and reservoir fluid sampling tool due to the above properties of the sealing member. In particular, since the sealing member exhibits high abrasion resistance at a higher temperature, seal life can be improved. The sealing member that exhibits lower friction ensures less wear and better seal life. The sealing member that exhibits better mechanical properties at a high temperature ensures better life and reliability. The sealing member that exhibits better chemical resistance may be exposed to various well and produced fluids at a high temperature.

For example, use of such a sealing member is disclosed in U.S. Pat. No. 6,058,773 and U.S. Pat. No. 3,653,436, the entire disclosure of which is incorporated by reference herein. Specifically, FIG. 2 of U.S. Pat. No. 6,058,773 discloses a reciprocating sealing member on a shuttle piston in a displacement unit (DU) located in a pump-out module. FIGS. 2, 3, and 4 of U.S. Pat. No. 3,653,436 disclose an elastomeric element that seals against a wellbore surface lined with a mudcake.

The sealing member according to one embodiment of the invention may also be applied to an in-situ fluid sampling bottle and an in-situ fluid analysis and sampling bottle, for example. Such a bottle may be used for a formation testing/reservoir fluid sampling tool or a wireline log/logging tool, for example. The in-situ fluid sampling bottle and the in-situ fluid analysis and sampling bottle require a sealing member that can be used under high pressure at a low temperature and a high temperature. The in-situ fluid sampling bottle and the in-situ fluid analysis and sampling bottle require a sealing member that exhibits high chemical resistance when exposed to a wide range of produced fluids. Moreover, the in-situ fluid sampling bottle and the in-situ fluid analysis and sampling bottle require a sealing member that exhibits gas resistance.

When using the in-situ fluid sampling bottle or the in-situ fluid analysis and sampling bottle, a reservoir fluid is captured under in-situ reservoir conditions at a high temperature and a high pressure. When retrieving the bottle to the surface, the temperature drops while the pressure stays high. After retrieval, the sample is moved to other storage, shipping, or analysis containers. The sealing member on a sliding piston in the sample bottle holds the following critical function during sample capture and sample export. For example, loss of the sample in situations (e.g., deep water fields) where low-temperature sealing for high pressure is not met when retrieved to the surface, loss of the sample at the surface during retrieval, loss of the sample from seal failures caused by chemical incompatibility with the sample and swelling from gas absorption issues, gas absorption in the seals that leads to swelling and increased friction/drag of the piston, extreme swelling of the sealing member that may lead to sticking and seal failures/safety issues while transferring the sample from the bottle to other storage or analysis devices, and problems due to use of multiple sample bottles in a stack during the operation may occur. Loss of the sample at the surface during retrieval may lead to problems especially when the sample contains H₂S, CH₄, CO₂, and the like.

The above problems can be solved by utilizing the sealing member according to one embodiment of the invention for the in-situ fluid sampling bottle and the in-situ fluid analysis and sampling bottle due to high gas resistance, high chemical resistance, and good low-temperature sealing performance while satisfying high-temperature/high-pressure properties in addition to the above properties of the sealing member.

For example, use of such a sealing member is disclosed in U.S. Pat. No. 6,058,773, U.S. Pat. No. 4,860,581, and U.S. Pat. No. 6,467,544 (Brown et al.), the entire disclosure of which is incorporated by reference herein. Specifically, FIG. 5 of U.S. Pat. No. 6,058,773 discloses a sealing member on a piston in a sample bottle. FIG. 2 of U.S. Pat. No. 4,860,581 discloses a two-bottle arrangement that includes a sealing member on a piston in a sample bottle. FIG. 1 of U.S. Pat. No. 6,467,544 discloses a sealing and shut-off valve.

The sealing member according to one embodiment of the invention may also be applied to an in-situ fluid analysis tool (IFA), for example. The in-situ fluid analysis tool requires a sealing member that exhibits high abrasion and gas resistance for downhole PVT. The term “PVT” means pressure/volume/temperature analysis. The in-situ fluid analysis tool requires a sealing member that exhibits high chemical resistance for handling produced fluids. The in-situ fluid analysis tool also requires a flow line static sealing member that exhibits high-temperature (about 210° C. or less)/high-pressure properties and high gas resistance. The term “flow line” refers to an area exposed to a sampled fluid.

For example, downhole PVT requires capturing a reservoir fluid sample and reducing the pressure to initiate gas formation and determine the bubble point. Depressurization is fast enough (e.g., greater than 3000 psi/min) so that a sealing member that is directly connected to a PVT sample chamber may be subjected to explosive decompression. The sealing member must be able to meet 200 or more PVT cycles. The sealing member for downhole PVT may fail by gas due to explosive decompression. Therefore, a commercially available sealing member does not allow downhole PVT at 210° C. A related-art sealing member in a flow line may show integrity issues from swelling and blistering from gas permeation.

The above problems can be solved by utilizing the sealing member according to one embodiment of the invention for the in-situ fluid analysis tool. The sealing member that exhibits better mechanical properties at high temperature and high pressure can reduce a swelling tendency. The sealing member in which voids are reduced by the carbon nanofibers exhibits high gas resistance. The sealing member with improved material properties exhibits high resistance to swelling and explosive decompression. The sealing member that exhibits high chemical resistance improves chemical resistance against a wide range of produced fluids.

For example, use of such a sealing member is disclosed in US-A-2009/0078412, U.S. Pat. No. 6,758,090, U.S. Pat. No. 4,782,695, and U.S. Pat. No. 7,461,547, the entire disclosure of which is incorporated by reference herein. Specifically, FIG. 5 of US-A-2009/0078412 discloses a sealing member on a valve, and FIG. 5 of US-A-2009/0078412 discloses a sealing member on a piston seal unit. FIG. 21a of U.S. Pat. No. 6,758,090 discloses a sealing member on a valve and a piston. U.S. Pat. No. 4,782,695 discloses a sealing member between a needle and a PVT chamber. U.S. Pat. No. 7,461,547 discloses a sealing member on a valve for isolating a fluid in PVCU as a sealing member in a piston-sleeve arrangement in a pressure volume control unit (PVCU) for PVT analysis.

The sealing member according to one embodiment of the invention may also be applied to all tools used for wireline log/logging, logging while drilling, well testing, perforation, and sampling operations, for example. Such a tool requires a sealing member that enables high-pressure sealing at a low temperature and a high temperature.

Such a tool requires a sealing member that works over a wide temperature range from a low temperature to a high temperature when used in deep water. When the sealing member does not properly work at a low temperature, leakage into air chambers such as electronic sections and tool failure may occur. A sampling operation in deepwater or cold areas such as the North Sea requires the sealing member to function over a wide temperature range from a low temperature to a high temperature. Specifically, the sample is still at a high pressure when the sample is retrieved, while the temperature drops to that of the surface conditions. For example, poor low-temperature sealing at a high pressure may lead to sample leakage, loss, and other problems. Since many of the tools are filled with hydraulic oil and pressurized to 100 to 200 psi, the tools may leak oil under cold surface conditions, or problems may occur during retrieval from the cold deep water section when the sealing member does not function well at a low temperature.

The above problems can be solved by utilizing the sealing member according to one embodiment of the invention for the above tools due to good low-temperature sealing performance, and better sealing capability at high temperature and high pressure due to better high-temperature mechanical properties in addition to the above properties of the sealing member.

The sealing member according to one embodiment of the invention may also be applied to a side wall coring tool, for example. The side wall coring tool requires a sealing member that exhibits lower friction and high abrasion resistance, a sealing member that has long life and high seal reliability, a sealing member that exhibits high-temperature (up to about 200° C.) properties, or a sealing member that has a value delta P of 100 psi or less (low speed sliding), for example. The term “delta P” refers to a pressure difference across the sealing member of the piston. For example, the value delta P decreases (i.e., the piston can be moved with a small pressure difference) when the sealing member has low friction.

For example, when the sealing member causes sticking or increased frictional force, the side wall coring tool may stop the coring operation. Drilling of each core requires the drill bit to rotate and slide by engaging with the sealing member while cutting into the formation. The sealing member must have low sealing friction in order to maintain a high core drilling efficiency.

The above problems can be solved by utilizing the sealing member according to one embodiment of the invention for the side wall coring tool due to the following properties in addition to the above properties of the sealing member. The sealing member with low friction can reduce power consumption for the core drilling operation and actuation/movement. The sealing member with low friction shows less tendency for sticking and rolling, thus improving the efficiency of the core drilling operation. The sealing member that exhibits high abrasion resistance can improve seal life in abrasive well fluids.

For example, use of such a sealing member is disclosed in US-A-2009/0133932, U.S. Pat. No. 4,714,119, and U.S. Pat. No. 7,191,831, the entire disclosure of which is incorporated by reference herein. Specifically, FIGS. 4 and 5 of US-A-2009/0133932 disclose a sealing member on a coring bit in a coring assembly driven by a motor. FIGS. 3B, 5, and 6 of U.S. Pat. No. 4,714,119 disclose a sealing member on a drill bit driven by a motor at 2000 rpm or less to advance and cut a core from a borehole. FIGS. 2A and 2B of U.S. Pat. No. 7,191,831 disclose a sealing member between a coring bit and a coring assembly driven by a motor. A high efficiency can be achieved by utilizing a low-friction sealing member such as the sealing member according to one embodiment of the invention at the interface between parts 201 to 204 (see FIGS. 3 and 4), or between a bit and a housing illustrated in FIG. 6B.

The sealing member according to one embodiment of the invention may also be applied to a telemetry and power generation tool in drilling applications, for example. The telemetry and power generation tool requires a rotating sealing member that exhibits high abrasion resistance, a rotating/sliding sealing member that exhibits low friction, or a sealing member that exhibits high-temperature (up to about 175° C.) properties, for example.

A mud pulse telemetry device such as disclosed in U.S. Pat. No. 7,083,008 depends on a rotary sealing member that protects the oil filled tool interior from the external well fluids (drilling mud), for example. However, since particulates are contained in the well fluids, wear and tear of the sealing member tend to increase. Seal failure from abrasion and wear of the sealing member may lead to mud invasion and tool failure. The telemetry and power tool disclosed in U.S. Pat. No. 7,083,008 works with a sliding sealing member on a piston that compensates the internal oil pressure with external fluids, and wear, abrasion, swelling, and sticking of the sealing member may lead to failure through external fluid invasion in the tool.

The above problems can be solved by utilizing the sealing member according to one embodiment of the invention for the telemetry and power generation tool due to better abrasion resistance and lower friction that allow more reliable operations and longer seal life in addition to the above properties of the sealing member.

For example, use of such a sealing member is disclosed in U.S. Pat. No. 7,083,008, the entire disclosure of which is incorporated by reference herein. Specifically, FIG. 2 of U.S. Pat. No. 7,083,008 discloses a rotary sealing member in a seal/bearing assembly between rotors, and FIG. 3a of U.S. Pat. No. 7,083,008 discloses a sliding sealing member on a compensating piston that separates oil and a well fluid (mud) in a pressure compensating chamber.

The sealing member according to one embodiment of the invention may also be applied to an inflate packer that is used for isolating part of a wellbore for sampling and formation testing, for example. A sealing member of the inflate packer must have high abrasion strength and high-temperature properties to allow repeated inflation-deflation operations at multiple wellbore locations.

A related-art packer sealing member tends to degrade and fail in sealing function due to the absence of desirable high-temperature properties. A related-art packer sealing member may show less than desirable life.

The above problems can be solved by utilizing the sealing member according to one embodiment of the invention for the inflate packer due to better abrasion resistance and better high-temperature properties so that the life and the reliability of the packing element can be improved.

For example, use of such a sealing member is disclosed in U.S. Pat. No. 7,578,342, U.S. Pat. No. 4,860,581, and U.S. Pat. No. 7,392,851, the entire disclosure of which is incorporated by reference herein. Specifically, FIGS. 1A, 1B, and 1C of U.S. Pat. No. 7,578,342 disclose that a sealing member inflates to seal against a borehole, and isolates a section indicated by reference numeral 16. An elastomer sealing element (packing element) illustrated in FIG. 4A of U.S. Pat. No. 7,578,342, or a member indicated by reference numeral 712 or 812 in FIGS. 5 and 6 of U.S. Pat. No. 7,578,342 corresponds to the sealing member. FIG. 1 of U.S. Pat. No. 4,860,581 discloses an inflate packing element that seals against a wellbore. U.S. Pat. No. 7,392,851 discloses an inflate packing element.

Although only some embodiments of the invention have been described in detail above, those skilled in the art would readily appreciate that many modifications are possible in the embodiments without materially departing from the novel teachings and advantages of the invention. Accordingly, such modifications are intended to be included within the scope of the invention.

### EXAMPLES

### (1) Preparation of Samples of Examples 1 to 13 and Comparative Examples 1 to 5

The invention is further described below by way of examples. Note that the invention is not limited to the following examples.

A perfluoroelastomer (FFKM) was supplied to open rolls (roll temperature: 10 to 20° C., roll distance: 0.5 to 1.0 mm), and masticated. Carbon black (FEF-CB or MT-CB) and carbon nanofibers (MWCNT-1, MWCNT-2, or MWCNT-3) in the amounts shown in Tables 1 to 4 were added to and mixed with the masticated perfluoroelastomer, and the mixture was removed from the open rolls. The mixture was wound around the open rolls (roll temperature: 10 to 20° C., roll distance: 0.3 mm), and tight-milled five times. The surface velocity ratio of the rolls was set to 1.1. A peroxide (PO) (crosslinking agent) and triallyl isocyanurate (TAIC) in the amounts shown in Tables 1 to 4 were added to and mixed with the uncrosslinked carbon fiber composite material obtained by tight-milling. The mixture was sheeted, and molded by press vulcanization and secondary vulcanization to obtain sheet-shaped crosslinked carbon fiber composite material samples (thickness: 1 mm) of Examples 1 to 13 and Comparative Examples 1 to 5.

In Tables 1 to 4, “FFKM” used in Examples 1 to 13 and Comparative Examples 1 to 4 indicates a perfluoroelastomer having a Mooney viscosity (ML₁₊₄ 100° C.) center value of 25, a TR-10 value of −30° C., and a peak temperature of the loss tangent (tandelta) of −15° C., “FFKM” used in Comparative Example 5 indicates a perfluoroelastomer having a Mooney viscosity (ML₁₊₄ 100° C.) center value of 35, a TR-10 value of −2° C., and a peak temperature of the loss tangent (tandelta) of 14.8° C., “FEF-CB” indicates FEF carbon black having an average particle size of 43 nm, “MT-CB” indicates MT carbon black having an average particle size of 200 nm, “MWCNT-1” indicates multi-walled carbon nanotubes having a bulk density of 45 to 95 kg/cm³ and an average diameter of 13 nm, “MWCNT-2” indicates multi-walled carbon nanotubes having a bulk density of 130 to 150 kg/cm³ and an average diameter of 13 nm, and “MWCNT-3” indicates multi-walled carbon nanotubes having an average diameter of 68 nm.

TABLE 1

| | | | Example 1 | Example 2 | Example 3 | Example 4 |
|---|---|---|---|---|---|---|
| Com- | FFKM | phr | 100 | 100 | 100 | 100 |
| ponent | PO | phr | 2.5 | 2.5 | 2.5 | 2.5 |
| | TAIC | phr | 3 | 3 | 3 | 3 |
| | FEF-CB | phr | 0 | 0 | 0 | 0 |
| | MT-CB | phr | 0 | 0 | 0 | 0 |
| | MWCNT- | phr | 10 | 20 | 0 | 0 |
| | 1 | | | | | |
| | MWCNT- | phr | 0 | 0 | 10 | 20 |
| | 2 | | | | | |
| | MWCNT- | phr | 0 | 0 | 0 | 0 |
| | 3 | | | | | |

TABLE 2

| | | | Example 5 | Example 6 | Example 7 | Example 8 |
|---|---|---|---|---|---|---|
| Com- | FFKM | phr | 100 | 100 | 100 | 100 |
| ponent | PO | phr | 2.5 | 2.5 | 2.5 | 2.5 |
| | TAIC | phr | 3 | 3 | 3 | 3 |
| | FEF-CB | phr | 0 | 0 | 0 | 0 |
| | MT-CB | phr | 40 | 40 | 40 | 15 |
| | MWCNT- | phr | 7 | 0 | 0 | 0 |
| | 1 | | | | | |
| | MWCNT- | phr | 0 | 7 | 0 | 0 |
| | 2 | | | | | |
| | MWCNT- | phr | 0 | 0 | 15 | 30 |
| | 3 | | | | | |

TABLE 3

| | | | Exam- | Exam- | Exam- | Exam- | Exam- |
|---|---|---|---|---|---|---|---|
| | | | ple | ple | ple | ple | ple |
| | | | 9 | 10 | 11 | 12 | 13 |
| Com- | FFKM | phr | 100 | 100 | 100 | 100 | 100 |
| ponent | PO | phr | 2.5 | 2.5 | 2.5 | 2.5 | 2.5 |
| | TAIC | phr | 3 | 3 | 3 | 3 | 3 |
| | FEF-CB | phr | 0 | 0 | 0 | 0 | 0 |
| | MT-CB | phr | 0 | 0 | 0 | 0 | 0 |
| | MWCNT- | phr | 5 | 0 | 0 | 0 | 0 |
| | 1 | | | | | | |
| | MWCNT- | phr | 0 | 5 | 0 | 0 | 0 |
| | 2 | | | | | | |
| | MWCNT- | phr | 0 | 0 | 5 | 10 | 20 |
| | 3 | | | | | | |

TABLE 4

| | | | Comparative | Comparative | Comparative | Comparative | Comparative |
|---|---|---|---|---|---|---|---|
| | | | Example 1 | Example 2 | Example 3 | Example 4 | Example 5 |
| Component | FFKM | phr | 100 | 100 | 100 | 100 | 100 |
| | PO | phr | 2.5 | 2.5 | 2.5 | 2.5 | 1.5 |
| | TAIC | phr | 3 | 3 | 3 | 3 | 1.5 |
| | FEF-CB | phr | 10 | 20 | 0 | 0 | 0 |
| | MT-CB | phr | 0 | 0 | 20 | 50 | 50 |

### (2) Physical Test

The rubber hardness (Hs (JIS-A)) of each of the crosslinked carbon fiber composite material samples of Examples 1 to 13 and Comparative Examples 1 to 5 was measured in accordance with JIS K 6253.

Specimens were prepared by punching the crosslinked carbon fiber composite material samples of Examples 1 to 13 and Comparative Examples 1 to 5 in the shape of a JIS No. 6 dumbbell. Each specimen was subjected to a tensile test in accordance with JIS K 6251 at a temperature of 23±2° C. and a tensile rate of 500 mm/min using a tensile tester (manufactured by Shimadzu Corporation) to measure the 50% modulus (sigma50 (MPa)), the 100% modulus (sigma100 (MPa)), the tensile strength (TS (MPa)), and the elongation at break (EB (%)).

The compression set (CS (%)) of each specimen (diameter: 29.0±0.5 mm, thickness: 12.5±0.5 mm) obtained from the crosslinked carbon fiber composite material samples of Examples 1 to 13 and Comparative Examples 1 to 5 was measured at a temperature of 200° C. and a compression rate of 25% for 70 hours in accordance with JIS K 6262.

JIS K 6252 angle specimens (uncut) were prepared by punching the crosslinked carbon fiber composite material samples of Examples 1 to 13 and Comparative Examples 1 to 5. Each specimen was subjected to a tear test in accordance with HS K 6252 at a tensile rate of 500 mm/min using an instrument Autograph AG-X (manufactured by Shimadzu Corporation) to measure the maximum tearing force (N). The measurement result was divided by the thickness (1 mm) of the specimen to determine the tearing strength (TR (N/mm)).

Specimens were prepared by punching the crosslinked carbon fiber composite material samples of Examples 1 to 13 and Comparative Examples 1 to 5 in the shape of a strip (40×1×2 (width) mm). Each specimen was subjected to a dynamic viscoelasticity test using a dynamic viscoelasticity tester “DMS6100” (manufactured by SII) at a chuck distance of 20 mm, a measurement temperature of −70 to 400° C., a frequency of 1 Hz, and a dynamic strain of ±0.05% in accordance with JIS K 6394 to measure the loss tangent (tandelta) and the peak temperature (° C.) of the loss tangent (tandelta) in the region near the glass transition temperature (Tg).

Specimens were prepared by punching the crosslinked carbon fiber composite material samples of Examples 1 to 13 and Comparative Examples 1 to 5 in the shape of a strip (40×1×2 (width) mm). Each specimen was subjected to a dynamic viscoelasticity test using a dynamic viscoelasticity tester DMS6100 (manufactured by SII) at a chuck distance of 20 mm, a measurement temperature of −70 to 400° C., a frequency of 1 Hz, and a dynamic strain of ±0.05% in accordance with JIS K 6394 to measure the dynamic storage modulus (E′ (MPa)) at 200° C.

Specimens were prepared by punching the crosslinked carbon fiber composite material samples of Examples 1 to 13 and Comparative Examples 1 to 5 in the shape of a strip (10 mm×4 mm (width)×1 mm (thickness)) illustrated in FIG. 4. A cut (depth: 1 mm) was formed in each specimen in the widthwise direction from the center of the long side. Each specimen was subjected to a tension fatigue test using a tester “TMA/SS6100” (manufactured by SII) by repeatedly applying a tensile load (0 to 2 N/mm) to the specimen in air at a temperature of 150° C., a maximum tensile stress of 2.0 N/mm, and a frequency of 1 Hz to measure the number of tensile load application operations (number of fatigue cycles (a)) performed until the specimen broke up to 200,000. A case where the specimen did not break when the number of tensile load application operations reached 200,000 is indicated by “200,000” in the tables. The tension fatigue life measured by the above tension fatigue test is referred to as a first number of tensile load application operations (number of fatigue cycles (a)). A tension fatigue test was performed in the same manner as described above, except for changing the tensile load to 0 to 2.5 N/mm, to measure the tension fatigue life that is indicated by a second number of tensile load application operations (number of fatigue cycles (b)). The ratio ((b)/(a)) of the second number of tensile load application operations to the first number of tensile load application operations was calculated.

In Tables 5 to 9, “Hs (JIS-A)” indicates the rubber hardness, “sigma50 (MPa)” indicates the 50% modulus, “sigma100 (MPa)” indicates the 100% modulus, “TS (MPa)” indicates the tensile strength, “Eb (%)” indicates the elongation at break, “CS (%)” indicates the compression set, “TR (N/mm)” indicates the tearing strength, “tandelta (° C.)” indicates the peak temperature of the loss tangent, “E′ (200° C.) (MPa)” indicates the dynamic storage modulus, “Number of fatigue cycles (a)” indicates the first number of tensile load application operations (tension fatigue life), “Number of fatigue cycles (b)” indicates the second number of tensile load application operations (tension fatigue life), and “(b)/(a)” indicates the tension fatigue life ratio.

TABLE 5

| | | Example 1 | Example 2 | Example 3 | Example 4 |
|---|---|---|---|---|---|
| Hs | JIS-A | 81 | 91 | 82 | 93 |
| sigma50 | MPa | 4.3 | 8.9 | 4.8 | 10.0 |
| sigma100 | MPa | 8.6 | 18.4 | 9.1 | 19.1 |
| TS | MPa | 19.3 | 26.8 | 20.8 | 28.1 |
| Eb | % | 250 | 150 | 220 | 140 |
| CS | % | 25 | 40 | 28 | 58 |
| TR | N/mm | 43.9 | 45.8 | 47.9 | 52.6 |
| tandelta | ° C. | −20.0 | −21.3 | −19.3 | −20.9 |
| E′(200° C.) | MPa | 27 | 135 | 36 | 187 |
| Number of | Number | 15,800 | 200,000 | 36,300 | 200,000 |
| fatigue | | | | | |
| cycles (a) | | | | | |

TABLE 6

| | | Example 5 | Example 6 | Example 7 | Example 8 |
|---|---|---|---|---|---|
| Hs | JIS-A | 87 | 88 | 88 | 90 |
| sigma50 | MPa | 6.2 | 6.7 | 7.5 | 8.8 |
| sigma100 | MPa | 13.5 | 14.5 | 15.6 | 17.2 |
| TS | MPa | 19.5 | 20.4 | 18.3 | 18.5 |
| Eb | % | 170 | 160 | 140 | 120 |
| CS | % | 24 | 27 | 22 | 25 |
| TR | N/mm | 44.8 | 46.7 | 42.8 | 40.4 |
| tandelta | ° C. | −20.0 | −19.5 | −19.8 | −19.6 |
| E′(200° C.) | MPa | 40 | 45 | 42 | 53 |
| Number of | Number | 10,500 | 12,400 | 11,000 | 28,200 |
| fatigue | | | | | |
| cycles (a) | | | | | |

TABLE 7

| | | Exam- | Exam- | Exam- | Exam- | Exam- |
|---|---|---|---|---|---|---|
| | | ple | ple | ple | ple | ple |
| | | 9 | 10 | 11 | 12 | 13 |
| Hs | JIS-A | 71 | 71 | 60 | 68 | 78 |
| sigma50 | MPa | 2.5 | 2.4 | 1.6 | 2.3 | 4.7 |
| sigma100 | MPa | 4.6 | 4.2 | 3.1 | 4.5 | 9.3 |
| TS | MPa | 11 | 12.4 | 8.1 | 9.9 | 13.7 |
| Eb | % | 220 | 240 | 240 | 220 | 180 |
| GS | % | 20 | 25 | 24 | 20 | 21 |
| TR | N/mm | 42.3 | 39.6 | 24.5 | 37.8 | 43.3 |
| tandelta | ° C. | −19.1 | −19.7 | −21.7 | −17.8 | −21.6 |
| E′ (200° C.) | MPa | 9.1 | 11 | 3.4 | 5.1 | 12 |
| Number of | Number | 4 | 4 | 1 | 2 | 25 |
| fatigue cycles | | | | | | |
| (a) | | | | | | |

TABLE 8

| | | Comparative | Comparative | Comparative | Comparative | Comparative |
|---|---|---|---|---|---|---|
| | | Example 1 | Example 2 | Example 3 | Example 4 | Example 5 |
| Hs | JIS-A | 64 | 75 | 66 | 84 | 90 |
| sigma50 | MPa | 1.4 | 2.3 | 1.8 | 4.6 | 18.0 |
| sigma100 | MPa | 2.5 | 4.8 | 3.3 | 7.7 | — |
| TS | MPa | 9.0 | 16.7 | 9.2 | 12.4 | 25.0 |
| Eb | % | 230 | 230 | 230 | 190 | 70 |
| CS | % | 21 | 21 | 17 | 18 | 15 |
| TR | N/mm | 26.3 | 30.4 | 25.6 | 31.7 | 23.2 |
| tandelta | ° C. | −17.0 | −19.2 | −19.3 | −19.1 | 14.5 |
| E′ (200° C.) | MPa | 3.5 | 7.2 | 3.8 | 12 | 18 |
| Number of | Number | 1 | 2 | 1 | 8 | 8 |
| fatigue cycles (a) | | | | | | |

TABLE 9

| | | Exam- | Exam- | Exam- | Comparative |
|---|---|---|---|---|---|
| | | ple 1 | le 2 | ple 3 | Example 4 |
| Number of | Number | 15,800 | 200,000 | 36,300 | 8 |
| fatigue | | | | | |
| cycles (a) | | | | | |
| Number of | Number | 10,200 | 200,000 | 28,500 | 1 |
| fatigue | | | | | |
| cycles (b) | | | | | |
| (b)/(a) | | 0.65 | 1 | 0.79 | 0.13 |

As shown in Tables 5 to 8, the crosslinked carbon fiber composite material samples of Examples 1 to 13 had a peak temperature of the loss tangent (tandelta) of −19° C. or less, while the crosslinked carbon fiber composite material sample of Comparative Example 5 had a peak temperature of the loss tangent (tandelta) of 14.5° C. The crosslinked carbon fiber composite material samples of Examples 1 to 10, 12, and 13 exhibited a tearing strength (TR) higher than that of the crosslinked carbon fiber composite material samples of Comparative Examples 1 to 5 containing carbon black in an amount of 0 to 50 parts by mass.

The crosslinked carbon fiber composite material samples of Comparative Examples 1 to 5 broke when the number of tensile load application operations (number of fatigue cycles (a)) was 1 to 8. On the other hand, the crosslinked carbon fiber composite material samples of Examples 1 to 8 broke when the number of tensile load application operations (number of fatigue cycles (a)) was 10,000 or more. Thus, it was considered that the crosslinked carbon fiber composite material samples of Examples 1 to 8 exhibited excellent abrasion resistance. As shown in Table 9, the crosslinked carbon fiber composite material samples of Examples 1 to 3 had a ratio “(b)/(a)” of 1, or had a ratio “(b)/(a)” closer to 1 as compared with the crosslinked carbon fiber composite material sample of Comparative Example 4. Thus, it was considered that the crosslinked carbon fiber composite material samples of Examples 1 to 3 exhibited excellent abrasion resistance under high pressure.

What is claimed is:

1. A sealing member obtained by molding a carbon fiber composite material comprising a perfluoroelastomer (FFKM), and carbon nanofibers dispersed in the perfluoroelastomer, the carbon nanofibers having an average diameter of 0.4 to 230 nm,
the perfluoroelastomer (FFKM) having a TR-10 value of −10° C. or less as measured by a temperature-retraction test (TR test) in accordance with JIS K 6261, and
the carbon fiber composite material in a crosslinked form having a peak temperature of a loss tangent (tandelta) of −15° C. or less as measured by a dynamic viscoelasticity test.

2. The sealing member according to claim 1,
wherein the carbon fiber composite material includes 7 to 35 parts by mass of the carbon nanofibers and 0 to 50 parts by mass of carbon black having an average particle size of 10 to 500 nm based on 100 parts by mass of the perfluoroelastomer, and
the carbon fiber composite material in a crosslinked form has a number of cycles to fracture of 10,000 or more when subjected to a tension fatigue test at a temperature of 200° C., a maximum tensile stress of 2 N/mm, and a frequency of 1 Hz.

3. The sealing member according to claim 1,
the sealing member being used for an oilfield apparatus.

4. The sealing member according to claim 3,
wherein the oilfield apparatus is a logging tool that performs a logging operation in a borehole.

5. The sealing member according to claim 3,
the sealing member being an endless sealing member that is disposed in the oilfield apparatus.

6. The sealing member according to claim 3,
the sealing member being a stator of a fluid-driven motor that is disposed in the oilfield apparatus.

7. The sealing member according to claim 6,
wherein the fluid-driven motor is a mud motor.

8. The sealing member according to claim 3,
the sealing member being a rotor of a fluid-driven motor that is disposed in the oilfield apparatus.

9. The sealing member according to claim 8,
wherein the fluid-driven motor is a mud motor.

10. A method of producing a sealing member comprising:
mixing a perfluoroelastomer (FFKM) and carbon nanofibers having an average diameter of 0.4 to 230 nm, and tight-milling the mixture at 0 to 50° C. using open rolls at a roll distance of 0.5 mm or less to obtain a carbon fiber composite material; and
molding the carbon fiber composite material to obtain a sealing member,
the perfluoroelastomer (FFKM) having a TR-10 value of −10° C. or less as measured by a temperature-retraction test (TR test) in accordance with JIS K 6261, and
the carbon fiber composite material in a crosslinked form having a peak temperature of a loss tangent (tandelta) of −15° C. or less as measured by a dynamic viscoelasticity test.
